(19) United States
(12) Patent Application Publication
(10) Pub. No.: US 2026/0185759 A1
(43) Pub. Date: Jul. 2, 2026

(54) REFRIGERATION APPARATUS

(71) Applicant: DAIKIN INDUSTRIES, LTD., Osaka (JP)

(72) Inventors: Tomoyuki GOTO, Osaka-shi (JP); Takashi YOSHIMURA, Osaka-shi (JP); Takashi USUI, Osaka-shi (JP); Taichi OZAKI, Osaka-shi (JP); Tomohito INOUE, Osaka-shi (JP)

(73) Assignee: DAIKIN INDUSTRIES, LTD., Osaka (JP)

(21) Appl. No.: 19/552,406

(22) Filed: Feb. 27, 2026

Related U.S. Application Data
(63) Continuation of application No. PCT/JP2024/032002, filed on Sep. 6, 2024.

(30) Foreign Application Priority Data
Sep. 15, 2023 (JP) 2023-150581

(51) Int. Cl. F25B 49/00; F25B 31/02; H01C 13/02; H01R 4/66

(52) U.S. Cl. CPC F25B 49/005; H01C 13/02; H01R 4/66; F25B 31/026

(57) ABSTRACT

A refrigeration apparatus includes a housing, a refrigerant circuit, a utilization power source, a ground line, and a grounding resistor. The refrigerant circuit circulates a refrigerant that is subject to potential disproportionation reaction. The utilization power source receives electrical power from a commercial power source. The ground line electrically connects the housing to an external ground. The grounding resistor is electrically connected to the ground line, and has a resistance equal to or more than 0.1Ω.

### CROSS REFERENCE TO RELATED APPLICATIONS

This application is a Continuation of PCT International Application No. PCT/JP2024/032002, filed on Sep. 6, 2024, which claims priority under 35 U.S.C. § 119 (a) to Patent Application No. JP 2023-150581, filed in Japan on Sep. 15, 2023, all of which are hereby expressly incorporated by reference into the present application.

### TECHNICAL FIELD

The present disclosure relates to a refrigeration apparatus and, in particular, to a refrigeration apparatus that includes a refrigerant circuit for circulating a refrigerant that possibly undergoes a disproportionation reaction.

### BACKGROUND ART

A refrigeration apparatus disclosed in Patent Literature 1 that is WO2018/168776 uses a refrigerant that is prone to a self-decomposition reaction known as a disproportionation reaction.

### SUMMARY

### Solution to Problem

A refrigeration apparatus in one aspect includes a housing, a refrigerant circuit, a power source unit, a ground line, and a grounding resistor. The refrigerant circuit circulates a refrigerant that possibly undergoes a disproportionation reaction. The power source unit receives electrical power from a commercial power source. The ground line electrically connects the housing to a ground outside the housing. The grounding resistor is electrically connected to the ground line, and has a resistance equal to or more than 0.12.

### BRIEF DESCRIPTION OF THE DRAWINGS

FIG. 1 is a schematic diagram showing a refrigerant circuit 60 and an electric system 40 of a refrigeration apparatus 90.

FIG. 2 is a schematic diagram showing the electric system 40.

FIG. 3 is a sectional view of a compressor 11.

FIG. 4 is a schematic diagram of the structure of a heat source unit 10.

FIG. 5 shows discharge locations in the compressor 11.

FIG. 6 shows a model that represents discharge in the compressor.

FIG. 7 is a graph showing the relationship between the discharge time, discharge energy, and resistance.

FIG. 8 is a graph showing the relationship between the refrigerant composition, refrigerant pressure, and discharge energy.

FIG. 9 is a graph showing a first condition by a dot.

FIG. 10 is a graph showing the first condition by a dot.

FIG. 11 is a graph showing a second condition by a dot.

FIG. 12 is a graph showing the second condition by a dot.

FIG. 13 is a graph showing a third condition by a dot.

FIG. 14 is a graph showing the third condition by a dot.

### DESCRIPTION OF EMBODIMENTS

### Embodiment

### (1) Entire Configuration

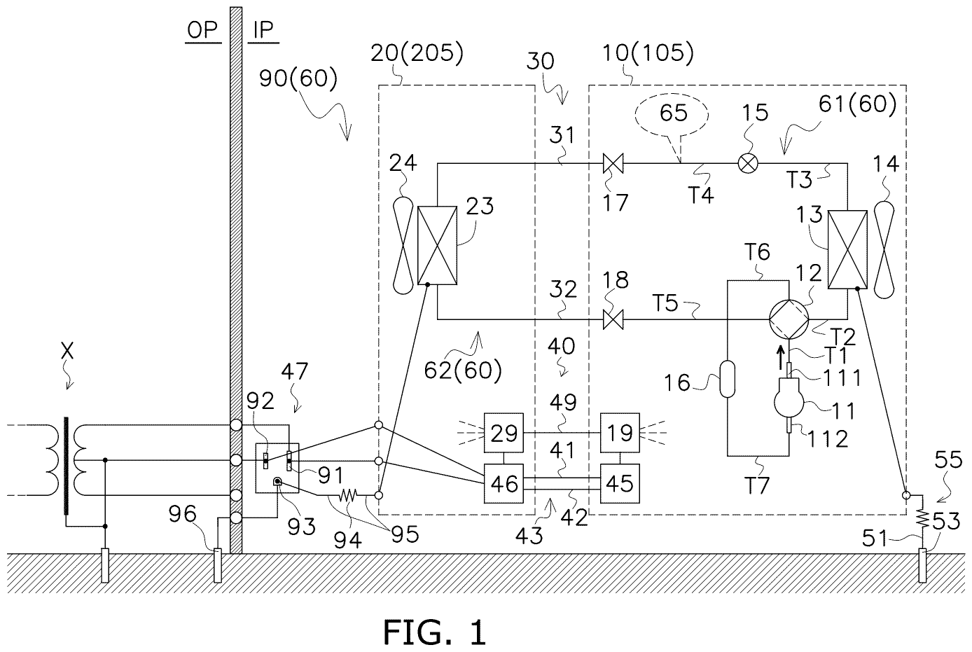

FIG. 1 is a schematic diagram showing a refrigerant circuit 60 and an electric system 40 of a refrigeration apparatus 90 according to the present disclosure. The refrigeration apparatus 90 may be configured as, for example, any of products, such as an air conditioner, a refrigerator, a hot water dispenser, a floor heater and the like. The refrigeration apparatus 90 includes a heat source unit 10, a utilization unit 20, a communication piping group 30, and a cable 43. The refrigeration apparatus 90 is installed in the inside area IP of the premises. The commercial power source 47 supplies electrical power to the refrigeration apparatus 90. The outlet of the commercial power source 47 transmits electrical power from a commercial power source transformer X provided in the outside area OP of the premises to the refrigeration apparatus 90.

### (2) Detailed Configuration

### (2-1) Heat Source Unit 10

The heat source unit 10 is for generating cold heat or hot heat from a heat source, such as external air. The heat source unit 10 includes a heat source housing 105, a compressor 11, a four-way valve 12, a heat source heat exchanger 13, a heat source fan 14, a heat source expansion valve 15, an accumulator 16, a liquid shut-off valve 17, a gas shut-off valve 18, and inner pipes T1 to T7. The heat source unit 10 further includes a heat source control unit 19, and a heat source power source unit 45, which constitute the electric system 40.

### (2-1-1) Compressor 11

The compressor 11 is a device that compresses refrigerant 65 in its low-pressure gas state, and thus brings it into a high-pressure gas state. The compressor 11 is arranged in the heat source housing 105. The compressor 11 includes a suction pipe 112 for suctioning the refrigerant 65, and a discharge pipe 111 for discharging the refrigerant 65. The structure of the compressor 11 will be described later.

### (2-1-2) Four-Way Valve 12

The four-way valve 12 is a device that switches a cold heat utilization operation for providing a user with cold heat, and a hot heat utilization operation for providing the user with hot heat, by switching the paths of the refrigerant 65. The details will be described later in description of the refrigerant circuit 60.

### (2-1-3) Heat Source Heat Exchanger 13

The heat source heat exchanger 13 is a device that exchanges heat between the refrigerant 65 and air. The heat source heat exchanger 13 functions as a condenser in the cold heat utilization operation, and functions as a vaporizer in the hot heat utilization operation. Alternatively, the heat source heat exchanger 13 may be a device that exchanges heat between a medium, such as water, and the refrigerant.

### (2-1-4) Heat Source Fan 14

The heat source fan 14 facilitates heat exchange in the heat source heat exchanger 13 by generating airflow. The airflow generated by the heat source fan 14 moves the air outside the heat source housing 105, which functions as a heat source, into the inside of the heat source housing 105, and moves the air that has exchanged heat with the refrigerant 65 in the heat source heat exchanger 13 to the outside of the heat source housing 105. The heat source fan 14 is driven by a heat source fan motor.

### (2-1-5) Heat Source Expansion Valve 15

The heat source expansion valve 15 is a feature for depressurizing the refrigerant 65 in the high-pressure liquid state into a low-pressure gas-liquid two-phase state. Furthermore, the heat source expansion valve 15 can regulate the circulation rate of the refrigerant 65.

### (2-1-6) Accumulator 16

The accumulator 16 is a container that removes and accumulates the component of the refrigerant 65 in the liquid state that is mixedly present in the refrigerant 65 in the gas state.

### (2-1-7) Liquid Shut-Off Valve 17 and Gas Shut-Off Valve 18

The liquid shut-off valve 17 and the gas shut-off valve 18 are valves that an installation operator of the refrigeration apparatus 90 manually opens and closes in order to block the paths of the refrigerant.

### (2-1-8) Inner Pipes T1 to T7

The inner pipes T1 to T7 are pipes that connect components arranged in the heat source housing 105. Specifically, the inner pipe T1 connects the discharge pipe 111 and the four-way valve 12. The inner pipe T2 connects the four-way valve 12 and the heat source heat exchanger 13. The inner pipe T3 connects the heat source heat exchanger 13 and the heat source expansion valve 15. The inner pipe T4 connects the heat source expansion valve 15 and the liquid shut-off valve 17. The inner pipe T5 connects the gas shut-off valve 18 and the four-way valve 12. The inner pipe T6 connects the four-way valve 12 and the accumulator 16. The inner pipe T7 connects the accumulator 16 and the suction pipe 112.

### (2-1-9) Heat Source Control Unit 19 and Heat Source Power Source Unit 45

The heat source control unit 19 reads the outputs of various sensors accommodated in the heat source unit 10 and controls various actuators. The heat source power source unit 45 prepares various power source voltages required by the heat source unit 10. The description of these units is supplemented in the description of the electric system 40.

### (2-2) Utilization Unit 20

The utilization unit 20 is for providing the user with cold heat or hot heat. The utilization unit 20 includes a utilization housing 205, a utilization heat exchanger 23, and a utilization fan 24. The utilization unit 20 further includes a utilization control unit 29 and a utilization power source unit 46, which are included in the electric system 40.

### (2-2-1) Utilization Heat Exchanger 23

The utilization heat exchanger 23 is a device that exchanges heat between the refrigerant 65 and air. The utilization heat exchanger 23 functions as a vaporizer in the cold heat utilization operation, and functions as a condenser in the hot heat utilization operation. Alternatively, the utilization heat exchanger 23 may be a device that exchanges heat between a medium, such as water, and the refrigerant. The utilization heat exchanger 23 is arranged in the utilization housing 205.

### (2-2-2) Utilization Fan 24

The utilization fan 24 facilitates heat exchange in the utilization heat exchanger 23 by generating airflow. In addition, in the case where the refrigeration apparatus 90 is an air conditioner, the utilization fan 24 delivers conditioned air to the position of the user. In the case where the refrigeration apparatus 90 is a hot water dispenser, the utilization fan 24 may be in the form of a pump to deliver hot water to the position of the user. The utilization fan 24 is driven by a utilization fan motor.

### (2-2-3) Utilization Control Unit 29 and Utilization Power Source Unit 46

The utilization control unit 29 reads the outputs of various sensors accommodated in the utilization unit 20 and controls various actuators. The utilization power source unit 46 prepares various power source voltages required by the utilization unit 20. The description of these units is supplemented in the description of the electric system 40.

### (2-3) Communication Piping Group 30

The communication piping group 30 consists of pipes that connect the heat source unit and the utilization unit 20. The communication piping group 30 includes a liquid communication pipe 31 and a gas communication pipe 32. The liquid communication pipe 31 connects the liquid shut-off valve 17 and the utilization heat exchanger 23. The gas communication pipe 32 connects the gas shut-off valve 18 and the utilization heat exchanger 23.

### (2-4) Cable 43

The cable 43 constitutes part of the electric system 40. The description of the cables 43 is supplemented in the description of the electric system 40.

### (3) Refrigerant Circuit 60

### (3-1) Refrigerant 65

The refrigerant circuit 60 circulates the refrigerant 65.

In the refrigerant circuit 60, the refrigerant 65 is compressed, radiates heat or condenses, is depressurized, absorbs heat or evaporates, and subsequently is compressed again. The refrigerant circuit 60 includes a heat source refrigerant circuit 61, a utilization refrigerant circuit 62, and a communication piping group 30. The heat source refrigerant circuit 61 is made up of part of the heat source unit 10. As the main elements, the heat source refrigerant circuit 61 includes the compressor 11, the four-way valve 12, the heat source heat exchanger 13, the heat source expansion valve 15, and the inner pipes T1 to T7. The utilization refrigerant circuit 62 is made up of part of the utilization unit 20. The utilization refrigerant circuit 62 includes the utilization heat exchanger 23.

The refrigerant 65 is of a type that possibly undergoes a disproportionation reaction.

The refrigerant 65 is a mixed refrigerant, and contains the following components 1 and 2.
Component 1: 1,2-difluoroethylene (HFO-1132)
Component 2: 2,3,3,3-tetrafluoropropene (HFO-1234yf)

Of the two components, the component 1 contributes more significantly to the occurrence of the disproportionation reaction. The molecular formula of the component 1 is as follows.

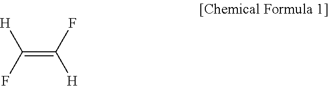

The component 1 may be, for example, cis-1,2-difluoroethylene (HFO-1132(Z)). Alternatively, the component 1 may be trans-1,2-difluoroethylene (HFO-1132(E)). Further alternatively, the component 1 may be trifluoroethylene (HFO-1123).

### (3-2) Cold Heat Utilization Operation

Referring to FIG. 1, the operation for the user to use cold heat will be described. In this case, the four-way valve 12 achieves the connection indicated by solid lines. The refrigerant 65 in the low-pressure gas state is compressed by the compressor 11. The refrigerant 65 in the high-pressure gas state is discharged from the discharge pipe 111. The refrigerant 65 in the high-pressure gas state is condensed by the heat source heat exchanger 13, and releases heat to the air in the process of coming into the high-pressure liquid state. Next, the refrigerant 65 in the high-pressure liquid state is depressurized by the heat source expansion valve 15, and comes into the low-pressure gas-liquid two-phase state. The refrigerant 65 in the low-pressure gas-liquid two-phase state is evaporated by the utilization heat exchanger 23, and takes heat from the air in the process of coming into the low-pressure gas state. This means that the refrigerant 65 provides cold heat to the environment of the user. The refrigerant 65 in the low-pressure gas state is deprived of a minute amount of liquid refrigerant mixedly present in the refrigerant 65 in the low-pressure gas state in the process of passing through the accumulator 16. Next, the refrigerant 65 in the low-pressure gas state is suctioned through the suction pipe 112 of the compressor 11.

### (3-3) Hot Heat Utilization Operation

Referring to FIG. 1, the operation for the user to use hot heat will be described. In this case, the four-way valve 12 achieves the connection indicated by broken lines. The refrigerant 65 in the low-pressure gas state is compressed by the compressor 11. The refrigerant 65 in the high-pressure gas state is discharged from the discharge pipe 111. The refrigerant 65 in the high-pressure gas state is condensed by the utilization heat exchanger 23, and releases heat to the air in the process of coming into the high-pressure liquid state. This means that the refrigerant 65 provides hot heat to the environment of the user. Next, the refrigerant 65 in the high-pressure liquid state is depressurized by the heat source expansion valve 15, and comes into the low-pressure gas-liquid two-phase state. The refrigerant 65 in the low-pressure gas-liquid two-phase state is evaporated by the heat source heat exchanger 13, and takes heat from the air in the process of coming into the low-pressure gas state. The refrigerant 65 in the low-pressure gas state is deprived of a minute amount of liquid refrigerant mixedly present in the refrigerant 65 in the low-pressure gas state in the process of passing through the accumulator 16. Next, the refrigerant 65 in the low-pressure gas state is suctioned through the suction pipe 112 of the compressor 11.

### (4) Electric System 40

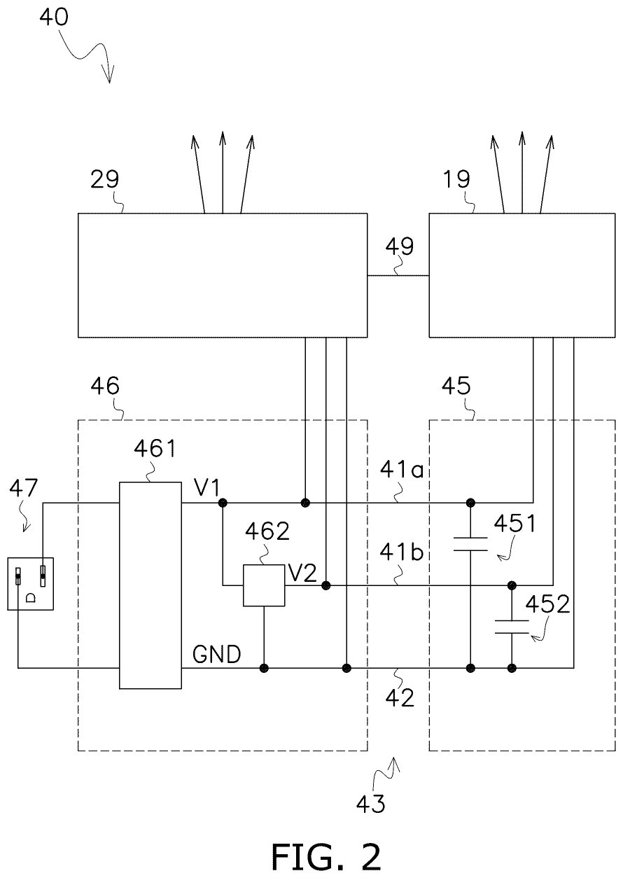

FIG. 2 is a schematic diagram showing the electric system 40 of the refrigeration apparatus 90. The electric system 40 includes the utilization power source unit 46, the utilization control unit 29, the heat source power source unit 45, and the heat source control unit 19.

### (4-1) Utilization Power Source Unit 46

The utilization power source unit 46 includes a rectifier 461 and a regulator 462. The rectifier 461 rectifies alternate current received from the commercial power source 47, thereby generating a direct-current power source voltage V1 with respect to the ground potential GND. The power source voltage V1 has a magnitude capable of driving various actuators that include a motor. The regulator 462 generates a power source voltage V2 that is lower than the power source voltage V1. The power source voltage V2 is used to drive a signal processing circuit that includes a processor.

### (4-2) Utilization Control Unit 29

The utilization control unit 29 is supplied with the power source voltage V1, the power source voltage V2, and the ground potential GND from the utilization power source unit 46, and generates control signals for driving various actuators that include the utilization fan 24.

### (4-3) Cable 43

The cable 43 connects the utilization unit 20 and the heat source unit 10, and constitutes part of the electric system 40. The cable 43 accommodates power source lines 41, a ground line 42, and a communication line 49. The power source lines 41 transmit the respective power source voltages. The power source lines 41 include a first power source line 41a and a second power source line 41b. The first power source line 41a transmits the power source voltage V1. The second power source line 41b transmits the power source voltage V2. The ground line 42 transmits the ground potential GND, which serves as a reference potential for the power source voltage. The communication line 49 transmits communication signals between the heat source control unit 19 and the utilization control unit 29.

### (4-4) Heat Source Power Source Unit 45

The heat source power source unit 45 includes capacitors 451 and 452 that smooth the power source voltages V1 and V2 transmitted via the cable 43.

### (4-5) Heat Source Control Unit 19

The heat source control unit 19 is supplied with the power source voltage V1, the power source voltage V2, and the ground potential GND from the heat source power source unit 45, and generates control signals for driving various actuators that include the compressor 11, the four-way valve 12, the heat source fan 14, and the heat source expansion valve 15. The heat source control unit 19 is connected to the utilization control unit 29 by the communication line 49. The communication line 49 is used for communication of various types of information that include commands, statuses, and data.

### (5) Structure of Compressor 11

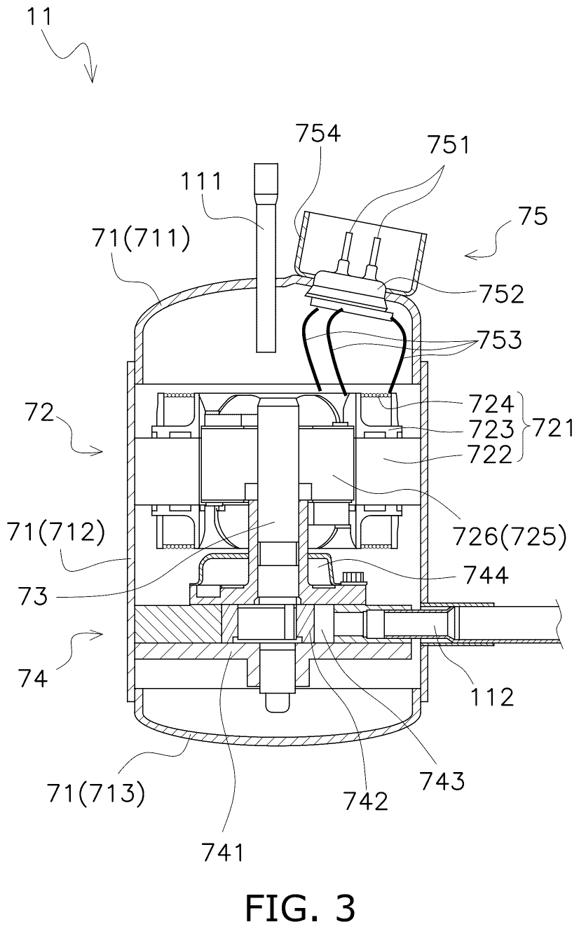

FIG. 3 shows a section of the compressor 11. The compressor 11 includes a compressor housing 71, a motor 72, a crankshaft 73, a compression mechanism 74, and a terminal unit 75.

### (5-1) Compressor Housing 71

The compressor housing 71 is a container that accommodates the components of the compressor 11. The compressor housing 71 further accommodates the refrigerant 65 and refrigerating machine oil. The compressor housing 71 includes an upper part 711, a cylindrical part 712, and a lower part 713 that are hermetically welded together, and has a structure that can withstand the high pressure of the refrigerant 65.

The compressor housing 71 is provided with the suction pipe 112 and the discharge pipe 111 described above. The suction pipe 112 is provided at a lower part of the cylindrical part 712. The discharge pipe 111 is provided at the upper part 711.

### (5-2) Motor 72

The motor 72 is a device that is supplied with electrical power, and generates power for driving the compression mechanism 74. The motor 72 is provided at an upper part of the cylindrical part 712. The motor 72 includes a stator 721 fixed to the compressor housing 71, and a rotor 725 that is installed in a rotatable manner.

The stator 721 includes a stator core 722 made of laminated steel plates, insulators 723 made of resin, and coils 724. A coil 724 is a winding wire wound around the stator core 722 and the insulators 723. The coil 724 generates an AC magnetic field.

The rotor 725 includes, a rotor core 726 made of laminated steel plates, and permanent magnets and end plates that are not shown. The permanent magnets interact with the AC magnetic field generated by the coils 724, thereby rotating the entire rotor 725. The end plates prevent the permanent magnets installed in a cavities provided in the rotor core 726 from being separated.

### (5-3) Crankshaft 73

The crankshaft 73 transmits the rotational force generated by the motor 72 to the compression mechanism 74.

### (5-4) Compression Mechanism 74

The compression mechanism 74 is provided at a lower part of the cylindrical part 712, and is connected to the suction pipe 112. The compression mechanism 74 includes a cylinder 741, a piston 742, and a muffler 744. The cylinder and the piston 742 define a compression chamber 743. The rotation of the crankshaft 73 revolves the piston 742, which varies the volume of the compression chamber 743. This compresses the refrigerant 65 in the low-pressure gas state suctioned through the suction pipe 112 into the high-pressure gas state. The pulsation of the pressure of the refrigerant 65 in the high-pressure gas state can be reduced by the muffler 744. This reduces the noise. The refrigerant 65 discharged from the muffler passes upward through gaps in the motor 72 (e.g., the gap between the stator 721 and the rotor 725, the core cut provided between the stator 721 and the cylindrical part 712, the gap between the adjacent coils 724 in the stator 721, etc.), and is subsequently discharged through the discharge pipe 111 to the outside of the compressor 11.

### (5-5) Terminal Unit 75

The terminal unit 75 takes electrical power supplied from the outside into the compressor 11. The terminal unit 75 includes terminal pins 751, a terminal base 752, leads 753, and a terminal guard 754. The terminal pins 751 are terminals to which external electric wires are connected. The terminal base 752 is a member for allowing the terminal pins 751 to stand on the compressor housing 71. The leads 753 connect the terminal pins 751 and the coils 724 of the motor 72. The terminal guard 754 is provided on the surface of the compressor housing 71, and surrounds the terminal pins 751, thereby restraining these terminal pins 751 from being damaged.

### (5-6) Protection Circuit

In case of short circuit occurring in an electric circuit of the compressor 11, the protection circuit cuts off the current. The protection circuit includes an inverter protection device, and a non-inverter sinusoidal wave breaker.

The inverter protection device is implemented in the heat source control unit 19. The inverter protection device includes current detection means, such as a shunt resistor. When the inverter output current having a current value exceeding a threshold is detected, the inverter protection device stops the inverter output current.

The non-inverter sinusoidal breaker is implemented in a distribution board of the commercial power source 47. The non-inverter sinusoidal breaker includes a zero-phase current transformer (ZCT), an earth leakage relay, and a breaker. In the case that an earth leakage occurs, the non-inverter sinusoidal breaker stops power supply from the commercial power source 47 to the refrigeration apparatus 90.

### (6) Grounding Path

### (6-1) Heat Source Unit 10

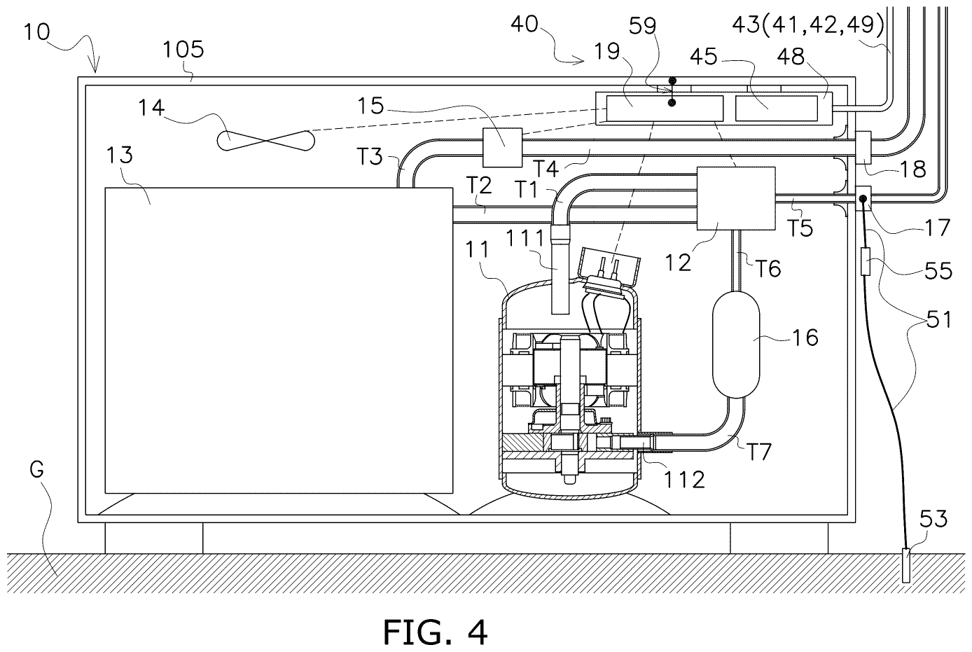

FIG. 4 is a schematic diagram of the structure of the heat source unit 10.

The heat source housing 105 is electrically connected to the liquid shut-off valve 17 and the gas shut-off valve 18. The liquid shut-off valve 17 and the gas shut-off valve 18 are electrically connected via the inner pipes T1 to T7 to part of the four-way valve 12, part of the accumulator 16, the compressor housing 71, part of the heat source expansion valve 15, and the heat source heat exchanger 13.

The ground line 51 is a conductive wire that connects the heat source housing 105 and the ground G, and has a function of guiding discharge energy occurring in the heat source unit 10 to the ground G. A buried portion 53 is implemented in the ground G on which the heat source unit 10 is grounded. The buried portion 53 is connected to the liquid shut-off valve 17 by the ground line 51. A grounding path that connects the heat source housing 105 and the ground G is formed by the ground line 51.

A grounding resistor 55 is connected to the middle of the ground line 51. The grounding resistor 55 consumes electric energy flowing through the ground line 51, and converts it into thermal energy. The grounding resistor 55 may be, for example, an electronic component physically connected to the ground line 51, or a grounding resistor. The heat source power source unit 45 and the heat source control unit 19, which constitute the electric system 40, are accommodated in an electrical equipment box 48. As shown in FIG. 4, the appropriate arrangement of the electrical equipment box 48 forms a conduction path 59 between the ground potential GND and the heat source housing 105 of the electric system 40. The presence of the conduction path 59 also electrically connects the ground potential GND of the electric system 40 to the ground line 51 and the ground G.

### (6-2) Utilization Unit 20

As shown in FIG. 1, the utilization heat exchanger 23 is electrically connected to the ground line 95 that extends to the outside of the utilization housing 205. A grounding resistor 94 is connected in series with the ground line 95. The grounding resistor 94 may be, for example, an electronic component physically connected to the ground line 95, or a grounding resistor.

The outlet of the commercial power source 47 includes a first power source terminal 91, a second power source terminal 92, and a ground terminal 93. The ground terminal 93 is electrically connected to a buried portion 96 buried in the ground. The ground line 95 of the utilization unit 20 is connected to the ground terminal 93. The ground terminal 93 is connected to the utilization heat exchanger 23 via the grounding resistor 94.

### (7) Mechanism of Disproportionation Reaction

The present applicants have discovered that applying discharge energy to the refrigerant 65 can induce the disproportionation reaction. The disproportionation reaction can be represented by the following chemical formula.

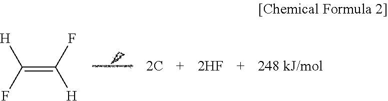

As known from this chemical formula, in the disproportionation reaction, the component 1 described above, which is 1,2-difluoroethylene (HFO-1132), in the refrigerant 65 is decomposed and generates heat. The heat generation further induces the decomposition of the unreacted refrigerant, which in turn induces a chain decomposition reaction. The induction in the refrigeration apparatus 90 can steeply increase the pressure in a short time period.

### (8) Discharge in Compressor 11

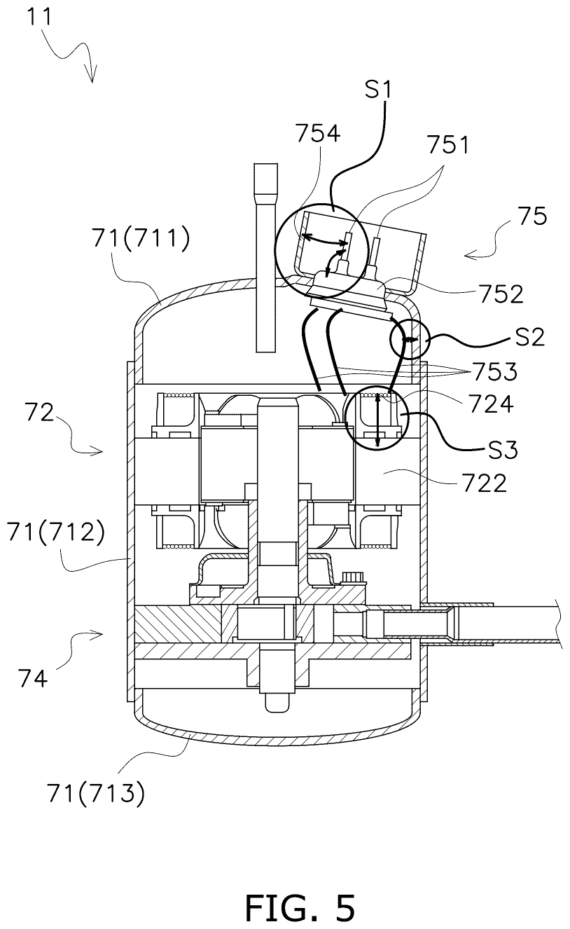

FIG. 5 shows discharge locations S1, S2, and S3 where discharge tends to occur within the compressor 11. The discharge location S1 is between the terminal pins 751 and the compressor housing 71. The compressor housing 71 described here includes a portion of the terminal base 752 that is electrically connected to the compressor housing 71, and also includes the terminal guard 754. The discharge location S2 is between the leads 753 and the compressor housing 71. The discharge location S3 is between the coil 724 and the stator core 722. The stator core 722 is electrically connected to the compressor housing 71. Discharge that tends to occur in the discharge locations S1 to S3 can induce the disproportionation reaction.

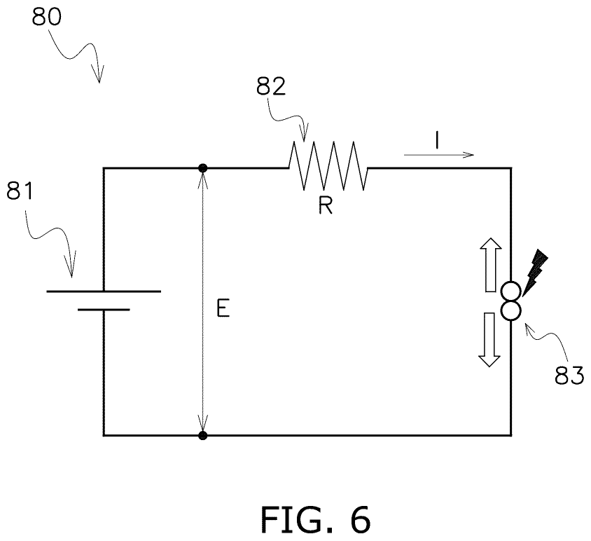

The discharge energy in the compressor can be calculated according to the model 80 shown in FIG. 6. The model 80 is a closed loop circuit that includes a DC power source 81, a resistor 82, and a movable contact 83 that are connected in series. The potential difference between the opposite terminals of the DC power source 81 is a contact-to-contact voltage E(V). The resistor 82 has a resistance R (Ω). The resistor 82 in the model 80 is for simulating the grounding resistor 55 or the grounding resistor 94 in the refrigeration apparatus 90. The movable contact 83 can set the discharge duration time T (s) by changing the distance between the contacts. The magnitude of current flowing through the movable contact 83 is a short-circuit current I (A). Provided that the discharge duration time is T (s), a discharge energy Dis.E (J) occurring at the movable contact 83 can be calculated by the following mathematical formula.

$$Dis . E [ J ] = {\int }_{0}^{T} {V}_{a r c} {I}_{a r c} dt = T [ \frac{1}{6} ( EI + {IE}_{m} + {EI}_{m} ) + \frac{1}{3} ( {E}_{m} {I}_{m} - \frac{I}{E} {E}_{m}^{2} - \frac{E}{I} {I}_{m}^{2} ) ] \qquad [ Mathematical Formula 1 ]$$

where the variables and constants are as follows.
   Dis.E (J): discharge energy
   E(V): power source voltage of circuit
   I (A): short-circuit current
   R (Ω): resistance
   T (s): discharge duration time
   Varc (V): contact-to-contact voltage at arc occurrence location
   Iarc (A): short-circuit current in case of arc occurrence
   Em: parameter determined by contact material
   Im: parameter determined by contact material

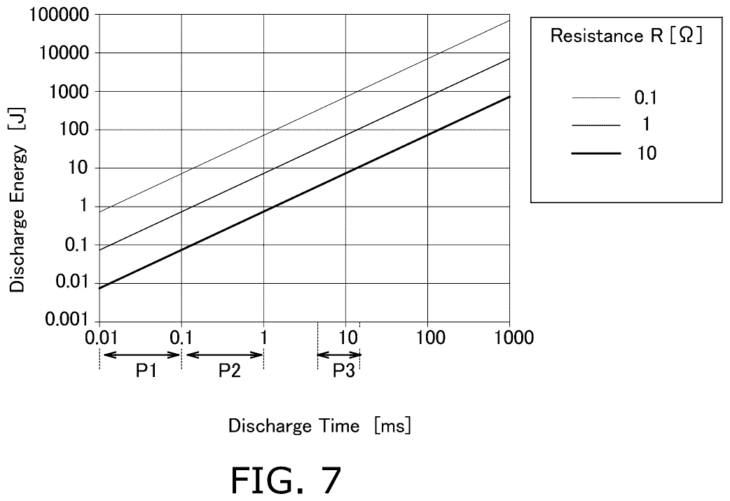

FIG. 7 is a graph where the discharge energy Dis.E (J), with the discharge duration time T (s) and the resistance R (Ω) being changed, is calculated using the aforementioned expression and plotted on logarithmic scales. Periods P1 to P3 serving as references are added on the abscissa axis that indicates the discharge duration time T (s). The period P1 is a time interval from the start of discharge to the start of operation of the inverter protection device. In the period P1, the inverter protection device operates. Accordingly, the compressor 11 is stopped. In the period P2, the voltage supplied to the motor 72 forms rectangular waves. The period P3 is the operation period for the non-inverter sinusoidal wave earth leakage breaker. After the period P3 elapses, the electrical power supply to the refrigeration apparatus 90 is stopped. The period P3, which is farthest from the discharge start, can lead to the maximum discharge duration time T (s). The time point that is 10 (ms) after the discharge start, which is the rear end of the period P3, can be considered as the maximum discharge duration time T (s).

### (9) Presence or Absence of Disproportionation Reaction

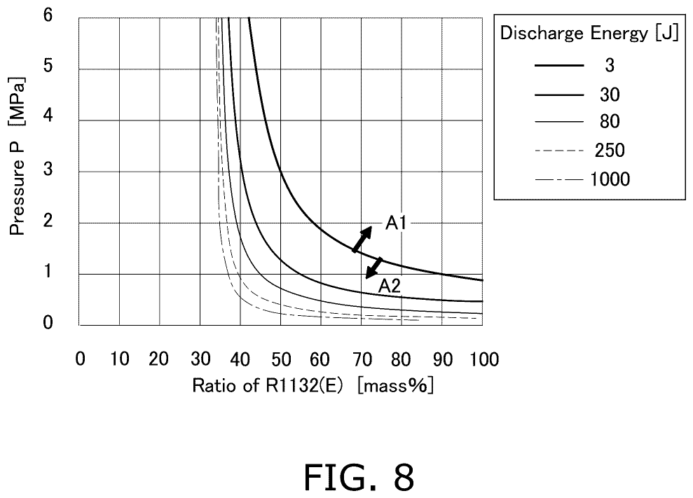

FIG. 8 is a graph showing the disproportionation occurrence boundary of each discharge energy Dis.E (J) with the content ratio (in mass %) and the pressure P (MPa) of HFO-1132 in the refrigerant 65 being changed. For example, when the discharge energy Dis.E (J) is 3 (J), the disproportionation reaction occurs in an area A1 in the diagram, whereas no disproportionation reaction occurs in an area A2.

As examples of conditions where no disproportionation reaction occurs, the following first to third conditions will be described.

### (9-1) First Condition

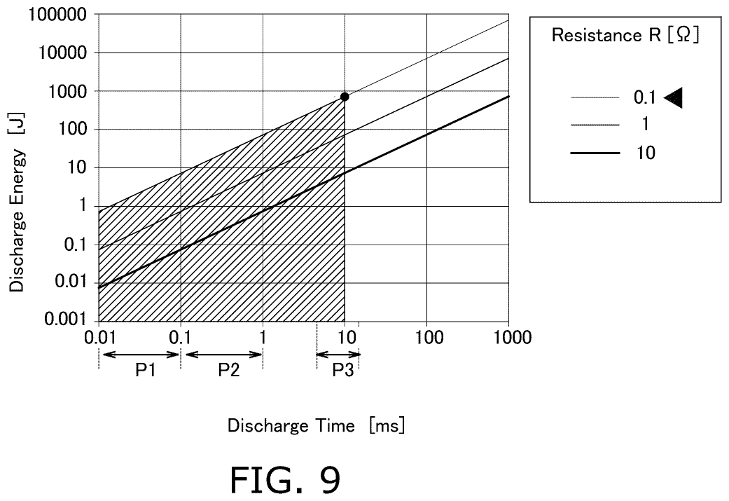

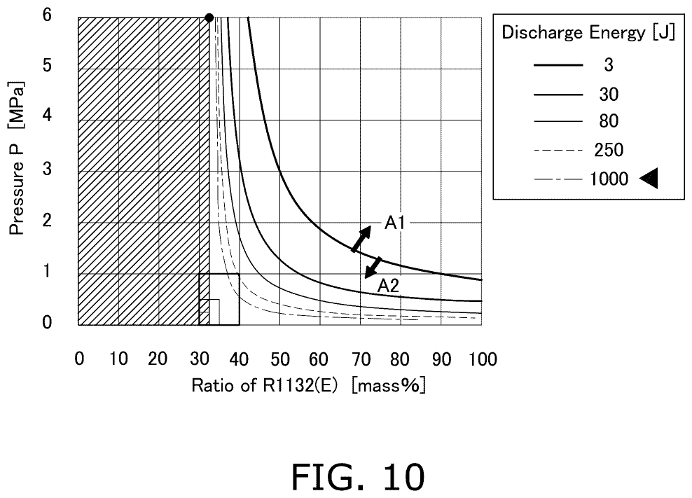

The first condition is hatched areas shown in FIGS. 9 and 10. Here, FIGS. 9 and 10 are made by adding the hatched areas and the like to FIGS. 7 and 8, respectively.

The first condition is as follows.

$$R \geq 0.1 ( Ω ) , \qquad FIG . 9$$

$$E \leq 1000 ( J ) , \qquad FIGS . 9 and 10$$

$$A \leq 55 ( in mass \% ) , and , \qquad FIG . 10$$

$$P \leq 6 ( MPa ) . \qquad FIG . 10$$

### (9-2) Second Condition

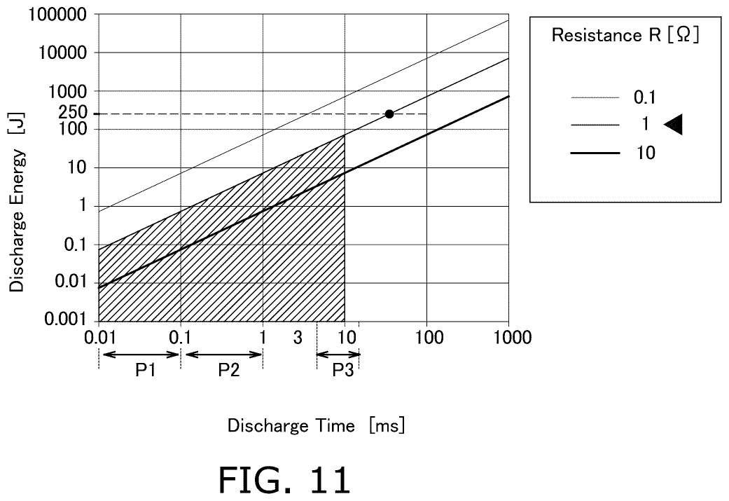

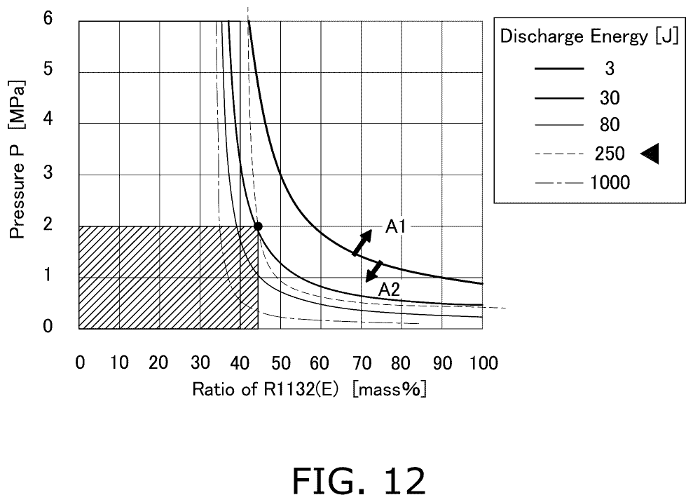

The second condition is hatched areas shown in FIGS. 11 and 12. Here, FIGS. 11 and 12 are made by adding the hatched areas and the like to FIGS. 7 and 8, respectively.

The second condition is as follows.

$$R \geq 10 ( Ω ) \qquad FIG . 11$$

$$E \leq 250 ( J ) , \qquad FIGS . 11 and 12$$

$$A \leq 45 ( in mass \% ) , and , \qquad FIG . 12$$

$$P \leq 2 ( MPa ) . \qquad FIG . 12$$

### (9-3) Third Condition

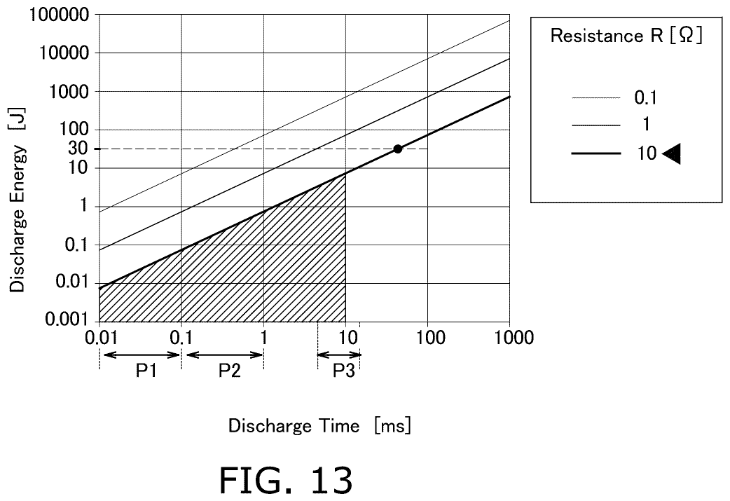

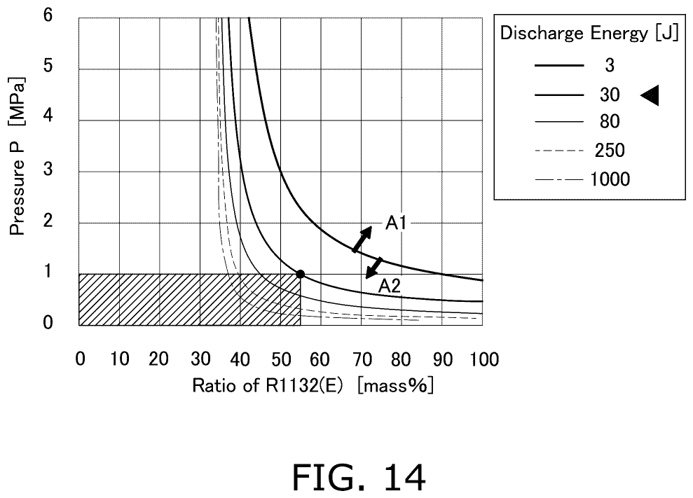

The third condition is hatched areas shown in FIGS. 13 and 14. Here, FIGS. 13 and 14 are made by adding the hatched areas and the like to FIGS. 7 and 8, respectively.

The third condition is as follows.

$$R \geq 10. ( Ω ) , \qquad FIG . 13$$

$$E \leq 30 ( J ) , \qquad FIGS . 13 and 14$$

$$A \leq 55 ( in mass \% ) , and , \qquad FIG . 14$$

$$P \leq 1 ( MPa ) \qquad FIG . 14$$

### (10) Characteristics

(10-1)

When the discharge energy Dis.E (J) that may cause a disproportionation reaction of the refrigerant 65 is generated in the refrigeration apparatus 90, the discharge energy Dis.E (J) can be consumed by the grounding resistor 55. Therefore, the disproportionation reaction of the refrigerant 65 in the refrigeration apparatus 90 can be suppressed.

(10-2)

The discharge energy that may cause a disproportionation reaction of the refrigerant 65 in the refrigeration apparatus 90 propagates through the ground line 51 electrically connected to the compressor housing 71, and is consumed by the grounding resistor 55. Therefore, the disproportionation reaction of the refrigerant 65 is suppressed.

(10-3)

The discharge energy that may cause a disproportionation reaction of the refrigerant 65 in the refrigeration apparatus 90 propagates through the ground line 95 electrically connected to the utilization heat exchanger 23, and is consumed by the grounding resistor 94. Therefore, the disproportionation reaction of the refrigerant 65 is suppressed.

(10-4)

In case a break occurs in one of the two ground lines, namely the ground line 51 and the ground line 95, the discharge energy propagates through the other, and is consumed by the grounding resistor 55 or the grounding resistor 94. Therefore, the disproportionation reaction of the refrigerant 65 is more securely suppressed.

(10-5)

The refrigerant 65 contains HFO-1132. Therefore, the disproportionation reaction of can be suppressed in HFO-1132, which is prone to the disproportionation reaction. The refrigerant 65 may further contain HFO-1134yf. Since the refrigerant 65 contains HFO-1134yf, the flammability of the refrigerant 65 can be reduced.

(10-6)

The grounding resistors 55 and 94 can sufficiently consume the discharge energy occurring in the refrigeration apparatus 90. Therefore, the refrigerant composition defined as “A” in the first to third conditions allows the disproportionation reaction to be suppressed.

(10-7)

The grounding resistors 55 and 94 are physically connected to the respective ground lines 51 and 95, and reformation of the inside of the housing is not required. Therefore, the space in the housing is not reduced.

### Modification Examples of Embodiment Described Above

### (11) Modification Examples

### (11-1) Modification Example A

According to the embodiment described above, the ground line 51 of the heat source unit 10 is provided with the grounding resistor 55, and the ground line 95 of the utilization unit 20 is also provided with the grounding resistor 94. Alternatively, only one of the grounding resistor 55 of the ground line 51 or the grounding resistor 94 of the ground line 95 may be provided.

### (11-2) Modification Example B

The conduction path 59 that electrically connects the ground potential GND of the electric system 40 and the heat source housing 105 is not necessarily provided. In other words, the ground potential GND may be insulated from the heat source housing 105.

### (11-3) Modification Example C

The configuration of the electric system 40 is not limited to those described above. For example, the heat source power source unit 45 may include a regulator, and generate the power source voltage V2 by itself. The heat source power source unit 45 itself may receive electrical power from the commercial power source 47. The number of power source lines 41 is not limited to two that are the first power source line 41a and the second power source line 41b, and may be one, or may be three or more.

### (11-4) Modification Example D

The grounding resistor 55 may be arranged in the heat source housing 105. For example, the grounding resistor 55 may be implemented on a circuit board of the electrical equipment box 48.

### (11-5) Modification Example E

The refrigeration apparatus 90 in the embodiment described above includes the heat source unit 10 and the utilization unit 20 that are separated from each other. Alternatively, the refrigeration apparatus 90 may be configured as a single unit that includes the heat source unit 10 and the utilization unit 20 that share the same housing.

### Conclusion

While the embodiments of the present disclosure have been described above, it can be understood that the forms and details may be variously changed without departing from the spirit and scope of the present disclosure described in the claims.

### REFERENCE SIGNS LIST

10: Heat source unit
11: Compressor
17: Liquid shut-off valve
18: Gas shut-off valve
19: Heat source control unit
20: Utilization unit
23: Utilization heat exchanger
29: Utilization control unit
30: Communication piping group
40: Electric system
41: Power source line
41a: First power source line
41b: Second power source line
42: Ground line
43: Cables
45: Heat source power source unit (power source unit)
46: Utilization power source unit
47: Commercial power source
48: Electrical equipment box
49: Communication line
51: Ground line (first ground line)
53: Buried portion
55: Grounding resistor (first grounding resistor)
59: Conduction path
60: Refrigerant circuit
61: Heat source refrigerant circuit (refrigerant circuit)
62: Utilization refrigerant circuit (refrigerant circuit)
65: Refrigerant
71: Compressor housing
72: Motor
73: Crankshaft
74: Compression mechanism
75: Terminal unit
90: Refrigeration apparatus
94: Grounding resistor (second grounding resistor)
95: Ground line (second ground line)
105: Heat source housing (housing)
111: Discharge pipe
112: Suction pipe
205: Utilization housing (housing)
711: Upper part
712: Cylindrical part
713: Lower part
721: Stator
722: Stator core
723: Insulator
724: Coil
725: Rotor
726: Rotor core
751: Terminal pins
752: Terminal base
753: Leads
754: Terminal guard
G: Ground
GND: Ground potential
E: Contact-to-contact voltage
I: Short-circuit current
T: Discharge duration time
A (in mass %): Refrigerant composition ratio
Dis.E (J): Discharge energy
P (MPa): Pressure
R (Ω): Resistance

### CITATION LIST

### Patent Literature

[Patent Literature 1] WO2018/168776

1. A refrigeration apparatus, comprising:
a housing;
a refrigerant circuit that circulates a refrigerant that is subject to potential disproportionation reaction;
a utilization power source that receives electrical power from a commercial power source;
a ground line that electrically connects the housing to a ground outside the housing; and
a grounding resistor that is electrically connected to the ground line, and has a resistance equal to or more than 0.1Ω.

2. The refrigeration apparatus according to claim 1, further comprising
a compressor that includes a compressor housing,
wherein the ground line is electrically connected to the compressor housing.

3. The refrigeration apparatus according to claim 1, further comprising
a utilization heat exchanger,
wherein the ground line is electrically connected to the utilization heat exchanger.

4. The refrigeration apparatus according to claim 1, further comprising:
a compressor that includes a compressor housing; and
a utilization heat exchanger,
wherein the grounding resistor includes:
a first grounding resistor; and
a second grounding resistor, and
the ground line includes:
a first ground line electrically connected to the first grounding resistor and the compressor housing; and
a second ground line electrically connected to the second grounding resistor and the utilization heat exchanger.

5. The refrigeration apparatus according to claim 1,
wherein the refrigerant contains 1,2-difluoroethylene (HFO-1132).

6. The refrigeration apparatus according to claim 5,
wherein the refrigerant further contains 2,3,3,3-tetrafluoropropene (HFO-1234yf).

7. The refrigeration apparatus according to claim 6,
wherein the resistance of the grounding resistor is R (Ω),
the ratio of the 1,2-difluoroethylene (HFO-1132) in the refrigerant is A (in mass %),
a discharge energy applied to the refrigerant is Dis.E (J),
a pressure when the refrigerant is used is P (MPa),
any of a first condition, a second condition, a third condition is satisfied, and
the first condition is
$$R \geq 0.1 ( Ω ) , E \leq 1000 ( J ) , A \leq 32 ( in mass \% ) , and \\ P \leq 6 ( MPa ) ,$$
the second condition is
$$R \geq 1. ( Ω ) , E \leq 250 ( J ) , A \leq 45 ( in mass \% ) , and \\ P \leq 2 ( MPa ) ,$$
and
the third condition is
$$R \geq 10. ( Ω ) , E \leq 30 ( J ) , A \leq 55 ( in mass \% ) , and \\ P \leq 1 ( MPa ) .$$

8. The refrigeration apparatus according to claim 1,
wherein the grounding resistor is physically connected to the ground line.

9. The refrigeration apparatus according to claim 1, further comprising
a utilization heat exchanger,
wherein the ground line is electrically connected to the utilization heat exchanger.

10. The refrigeration apparatus according to claim 2,
wherein the refrigerant contains 1,2-difluoroethylene (HFO-1132).

11. The refrigeration apparatus according to claim 3,
wherein the refrigerant contains 1,2-difluoroethylene (HFO-1132).

12. The refrigeration apparatus according to claim 4,
wherein the refrigerant contains 1,2-difluoroethylene (HFO-1132).

13. The refrigeration apparatus according to claim 2,
wherein the grounding resistor is physically connected to the ground line.

14. The refrigeration apparatus according to claim 3,
wherein the grounding resistor is physically connected to the ground line.

15. The refrigeration apparatus according to claim 4,
wherein the grounding resistor is physically connected to the ground line.

16. The refrigeration apparatus according to claim 5,
wherein the grounding resistor is physically connected to the ground line.

17. The refrigeration apparatus according to claim 6,
wherein the grounding resistor is physically connected to the ground line.

18. The refrigeration apparatus according to claim 7,
wherein the grounding resistor is physically connected to the ground line.
